(19) United States
(12) Patent Application Publication
(10) Pub. No.: US 2014/0360305 A1
(43) Pub. Date: Dec. 11, 2014

(54) ROTATION PRESERVING QUICK CONNECT DEVICE

(71) Applicant: The Johns Hopkins University, Baltimore, MD (US)

(72) Inventors: Kevin Olds, Baltimore, MD (US); Russell H. Taylor, Severna Park, MD (US)

(21) Appl. No.: 14/299,082

(22) Filed: Jun. 9, 2014

Related U.S. Application Data
(60) Provisional application No. 61/832,336, filed on Jun. 7, 2013.

(51) Int. Cl. B25J 15/00; B23B 31/02

(52) U.S. Cl. CPC B25J 15/0019; B23B 31/02; Y10S 901/41
USPC 74/490.01; 279/128; 901/41

(57) ABSTRACT

The present invention is directed to a tool holder for use with a surgical robot. The tool holder includes, a rotor fixed to the tool shaft, and a stator fixed to the robot. The stator includes a magnet, and a bearing surface. The rotor includes a magnetic material that attaches securely to the tool shaft, such that the tool is in the center of the rotor. The rotor rotates against the bearing surface on the stator, allowing the tool to rotate about its axis. To exchange tools, the user exerts force on the tool until the holding force of the magnet is exceeded and the tool detaches from the stator. A new tool is introduced into the vicinity of the stator such that the magnet attracts the magnetic material on the rotor. The present invention eliminates the need to slide the tool through a shaft of the tool holder.

### CROSS REFERNCE TO RELATED APPLICATION

This application claims the benefit of U.S. Provisional Patent Application No. 61/832,336, filed Jun. 7, 2013, which is incorporated by reference herein, in its entirety.

### FIELD OF THE INVENTION

The present invention relates generally to surgery. More particularly, the present invention relates to a device for use in robotic surgery.

### BACKGROUND OF THE INVENTION

Surgical robots are increasingly used to aid in the performance of surgical procedures. In one exemplary surgical robot, a cooperative control method, the robot and the user both hold a tool, and the robot moves according to the force the user exerts on the tool. Typically, the tool attaches to the robot using a quick release tool holder. The quick release tool holder allows for easy exchange of different tools and fast removal of a tool in case of emergency. Because these robots typically control 5 degrees-of-freedom of the tool the 6^{th} degree-of-freedom, or rotation of the tool about its axis, is left passive. Often, the tools used by the robot are needle-shaped, and it is easy to insert them through a cylindrical tool holder defining a hole through the middle to accommodate a shaft of the tool, referred to herein as the tool shaft.

One type of surgical tool for use in eye surgery is illustrated in FIG. 1. As illustrated in FIG. 1 the eye surgery tool is generally needle-like in shape and the tip of the tool is narrower than the tool shaft. FIG. 2 illustrates a typical tool holder mounted on an exemplary surgical robot, and FIG. 3 illustrates the eye surgery tool of FIG. 1 inserted into the tool shaft of the tool holder illustrated in FIG. 2.

In contrast to the tool for eye surgery illustrated in FIG. 1, some surgical tools have tips that are significantly larger than the tool shaft. If the same tool holder approach illustrated in FIGS. 2 and 3 was used, the hole through the tool holder would have to be enlarged to clear the tip. Increasing the size of the tool holder would make it unfeasibly large for head and neck surgery, or other surgeries in small or tight spaces. Also, it is cumbersome to slide the entire shaft of a long tool through the tool shaft of the tool holder.

Accordingly, there is a need in the art for a tool holding device that can be used with a surgical robot and, at least, accommodates tools with shapes and lengths not accommodated by current tool holders.

### SUMMARY OF THE INVENTION

The foregoing needs are met, to a great extent, by the present invention which provides a tool holder for a surgical robot, including a rotor configured to be coupled to a surgical tool, imaging device, or implant. The rotor is releasably coupled to the surgical tool, imaging device, or implant. The present invention also includes a stator. The stator includes a housing, a magnet coupled to the housing, as well as a bearing surface.

In accordance with an aspect of the present invention, the rotor can be formed from a magnetic material, such that the magnetic material facilitates the coupling of the rotor and the surgical tool. Alternately, the rotor can include a rotor magnet configured such that the magnet facilitates the coupling of the rotor and the surgical tool. The magnetic material or the rotor magnet further takes the form of a material configured to be magnetically attracted to the magnet of the stator. The bearing surface is defined by the housing of the stator or alternately, is coupled to the stator. The bearing surface includes a first bearing surface and a second bearing surface and can be adjusted in size. The rotor can also be configured to nest, at least partially between the first and second bearing surfaces.

### BRIEF DESCRIPTION OF THE DRAWINGS

The accompanying drawings provide visual representations, which will be used to more fully describe the representative embodiments disclosed herein and can be used by those skilled in the art to better understand them and their inherent advantages. In these drawings, like reference numerals identify corresponding elements and:

FIG. 1 illustrates an exemplary eye surgery tool.

FIG. 2 illustrates an example of a typical tool holder mounted on an exemplary surgical robot.

FIG. 3 illustrates the eye surgery tool of FIG. 1 inserted into a tool shaft of the tool holder illustrated in FIG. 2.

FIG. 4A illustrates a left-side schematic view of a tool holder according to an embodiment of the present invention.

FIG. 4B illustrates a top-down schematic view of a tool holder according to an embodiment of the present invention.

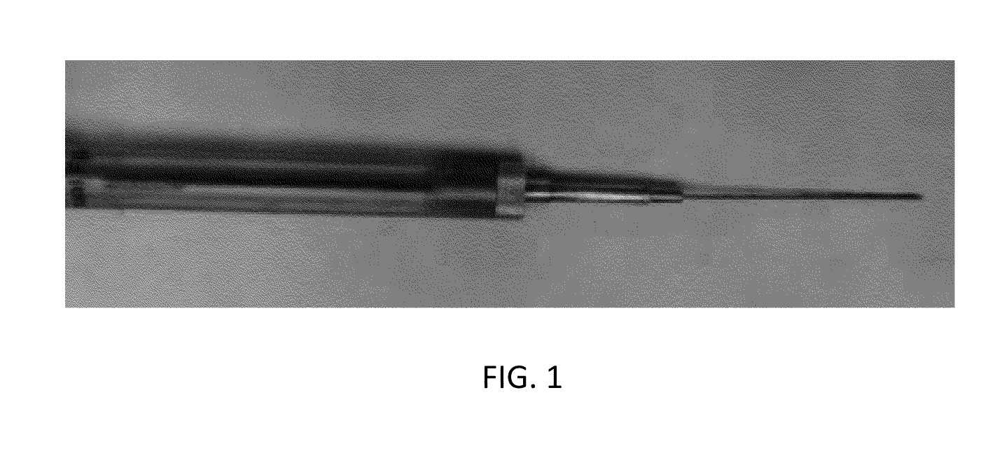

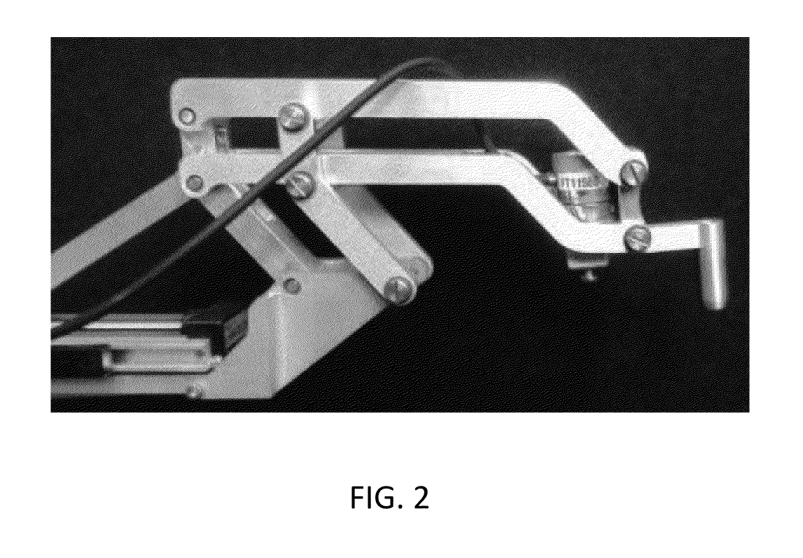

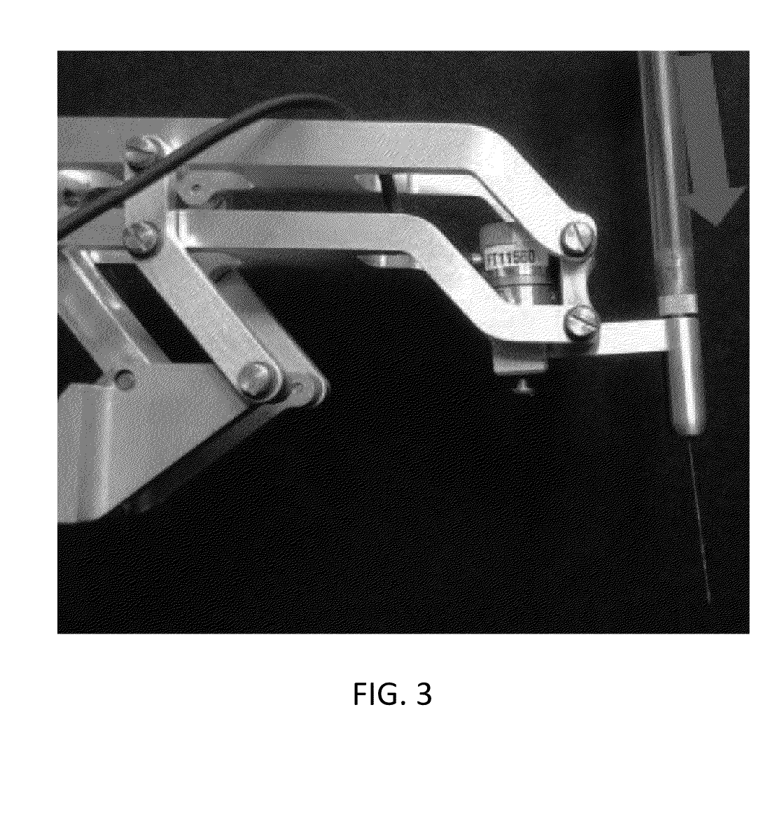

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The present invention is directed to a novel tool holder that does not require the tool to be inserted through it. The tool holder is comprised of two main parts, a rotor that is fixed to the tool shaft, and a stator that is fixed to the robot. The stator includes a magnet and a bearing surface. The rotor includes a magnetic material that attaches securely to the tool shaft such that the tool is in the center. The rotor rotates against the bearing surface on the stator, allowing the tool to rotate about its axis. In order to exchange tools, the user exerts force on the tool until the holding force of the magnet is exceeded, which causes the tool to detach from the stator. Then a new tool is introduced into the vicinity of the stator such that the magnet attracts the magnetic material on the rotor, holding it against the bearing surface.

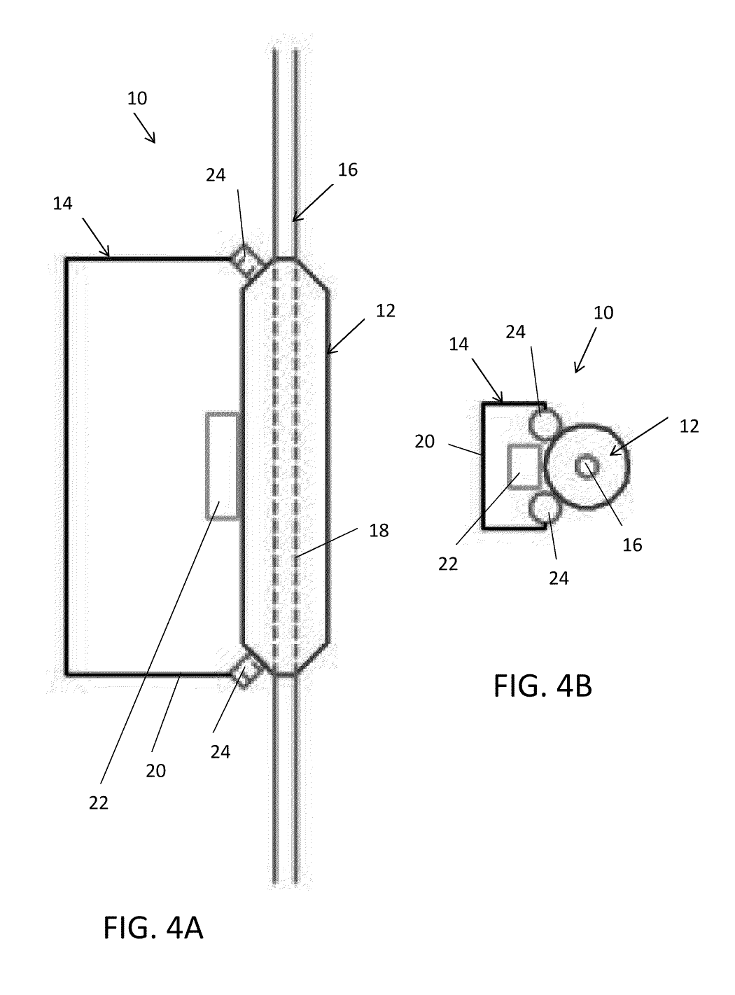

FIG. 4A illustrates a left-side schematic view of an embodiment of a tool holder according to the present invention and FIG. 4B illustrates a top-down schematic view of an embodiment of the tool holder according to the present invention. As illustrated in FIGS. 4A and 4B, the tool holder 10 includes two main parts, a rotor 12 and a stator 14. The rotor 12 is fixable to a surgical tool 16, such as by securing the rotor 12 to a shaft 18 of the surgical tool 16. The rotor 12 is preferably formed from a magnetic material, such that the rotor 12 is attachable to the tool shaft 18 using the magnet. Alternately, the rotor 12 can be formed from a non-magnetic material configured to house a magnet inside the rotor 12, or any other suitable material known to one of skill in the art, such that the rotor 12 can be securely coupled to the tool shaft 18. The rotor 12 can be configured to at least partially surround the tool shaft 18. However, the rotor 12 can also be configured in any way suitable to hold the surgical tool 16 for use with the surgical robot.

It should be noted that while a magnet is disclosed herein, other means of holding the surgical tool secure could also be used, such as friction, suction, adhesion, etc. The surgical tool may also have to be modified slightly, in some instances. For example, if a non-magnetic surgical tool is being used, one or more magnets can be added in or around the surgical tool (such as in or around the shaft of the tool) to facilitate holding of the tool shaft 18 with the rotor 12. Additionally, a supplemental tool handle, configured to couple with the rotor can be placed around the tool shaft 18, in order to facilitate use of the rotor and stator system of the present invention.

As illustrated in FIGS. 4A and 4B, the stator 14 includes a housing 20, a magnet 22 disposed within or coupled to the housing 20, and a bearing surface 24 defined by or coupled to the housing 20. The bearing surface 24 can take the form of a first bearing surface and a second bearing surface. In such a case the first and second bearing surfaces can be positioned on either side of the magnet 22, preferably at or near the corners of the stator 14.

As noted above, but presently described with respect to FIGS. 4A and 4B, the rotor 12 rotates against the bearing surface 24 on the stator 14, allowing the tool 16 to rotate about its axis. In order to exchange tools, the user exerts force on the tool 16 until the holding force of the magnet 22 is exceeded, which causes the tool 16 to detach from the stator 14. Then a new tool is introduced into the vicinity of the stator 14 such that the magnet 22 attracts the magnetic material on the rotor 12, holding it against the bearing surface 24. The rotor 12 can also be configured such that it nests, at least in part, between the first and second bearing surfaces. While the present invention is described with respect to holding a surgical tool, it could also be used for any purpose known to or conceivable by one of skill in the art, such as holding an imaging device or implant.

The tool holder of the present invention can be used with any suitable surgical robot known to or conceivable by one of skill in the art. One exemplary surgical robot, with which the tool holder can be used, is a steady-hand robot. In cooperative steady-hand robot control, both the robot and surgeon hold tooling attached to the robot's end effector. A force sensor detects forces exerted by the surgeon and the robot moves to comply. However, this compliant behavior may be modified by “virtual fixtures”, which are well known in the robotic art, based on sensor values or task geometry. Alternative means of robot control, such as conventional teleoperation, may also be used, and the robot behavior can be modified by means of virtual fixtures to help the surgeon achieve the desired task.

It should be noted that the tool holder of the present invention and the method associated with it offer several advantages over conventional tool holders. For instance, there is a maximum force that can be exerted on the tool before it detaches, which can protect the robot, stator, rotor, tool, and work from excessive force. Long tools don't need to be inserted all the way down through the tool holder, they can simply attach and detach directly from the side. Tools with thin shafts but bulky tips can easily be used, because the tool tip does not have to be inserted through the tool holder. Holding force can be adjusted by adjusting the distance from the magnets to the rotor. This could be done by adjusting the bearing surfaces, or using any other means known to or conceivable by one of skill in the art.

Additional features could also be added to the design of the present invention including, but not limited to, an encoder to encode the rotational position of the rotor with respect to the stator. The present invention could also include a gripper, motorized or manual, to fix the rotor in position with respect to the stator, and/or a spur gear to motorize the rotation of the tool, or lock it from rotating. Additionally, the present invention could include a mechanism (pneumatic, mechanical, electromagnetic, etc.) to retract the magnets or otherwise counteract or reduce the magnetic force exerted by the magnets so that the tool is freed. This mechanism could be implemented in any way known to or conceivable to one of skill in the art.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A tool holder for use with a surgical robot, comprising:
a rotor configured to be coupled to a surgical tool, imaging device, or implant, such that the rotor is releasably coupled to the surgical tool, imaging device, or implant; and
a stator including a housing, wherein said stator further includes a magnet coupled to the housing and a bearing surface.

2. The tool holder of claim 1 wherein the rotor further comprises a magnetic material, such that the magnetic material facilitates the coupling of the rotor and the surgical tool.

3. The tool holder of claim 2 wherein the magnetic material further comprises a material configured to be magnetically attracted to the magnet of the stator.

4. The tool holder of claim 1 wherein the rotor further comprises a rotor magnet configured such that the magnet facilitates the coupling of the rotor and the surgical tool.

5. The tool holder of claim 4 further comprising the rotor magnet being configured such that it is magnetically attracted to the magnet of the stator.

6. The tool holder of claim 1 wherein the bearing surface is defined by the housing of the stator.

7. The tool holder of claim 1 wherein the bearing surface comprises a first bearing surface and a second bearing surface.

8. The tool holder of claim 1 wherein the bearing surface can be adjusted in size.

9. The tool holder of claim 1 wherein the bearing surface is coupled to the housing.

10. The tool holder of claim 7 wherein the rotor is configured to nest, at least partially between the first and second bearing surfaces.

11. A system for robotic surgery comprising:
a surgical robot;
a tool holder for use with the surgical robot, wherein the tool holder comprises:
a rotor configured to be coupled to a surgical tool, imaging device, or implant, such that the rotor is releasably coupled to the surgical tool, imaging device, or implant; and
a stator including a housing, wherein said stator further includes a magnet coupled to the housing and a bearing surface.

12. The system for robotic surgery of claim 11 further comprising the tool holder being permanently integrated into the surgical robot.

13. The system for robotic surgery of claim 11 further comprising the tool holder being removable from the surgical robot.

14. The system for robotic surgery of claim 11 wherein the rotor further comprises a magnetic material, such that the magnetic material facilitates the coupling of the rotor and the surgical tool.

15. The system for robotic surgery of claim 14 wherein the magnetic material further comprises a material configured to be magnetically attracted to the magnet of the stator.

16. The system for robotic surgery of claim 11 wherein the rotor further comprises a rotor magnet configured such that the magnet facilitates the coupling of the rotor and the surgical tool.

17. The system for robotic surgery of claim 16 further comprising the rotor magnet being configured such that it is magnetically attracted to the magnet of the stator.

18. The system for robotic surgery of claim 11 wherein the bearing surface is defined by the housing of the stator.

19. The system for robotic surgery of claim 11 wherein the bearing surface comprises a first bearing surface and a second bearing surface.

20. The system for robotic surgery of claim 11 wherein the bearing surface can be adjusted in size.

21. The system for robotic surgery of claim 11 wherein the bearing surface is coupled to the housing.

22. The system for robotic surgery of claim 19 wherein the rotor is configured to nest, at least partially between the first and second bearing surfaces.
